(19) United States
(12) Patent Application Publication
(10) Pub. No.: US 2005/0248523 A1
(43) Pub. Date: Nov. 10, 2005

(54) [A LCD LIGHTING CONTROL SYSTEM]

(76) Inventors: Andre Yu, Taipei City (TW); Tim Yu, Taipei County (TW); Jason Lee, Taipei City (TW); Felix Lai, Keelung City (TW); Bill Huang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,907

(22) Filed: Aug. 12, 2004

(30) Foreign Application Priority Data
May 4, 2004 (TW) 93112469

(51) Int. Cl. G09G 3/36

(52) U.S. Cl. 345/102

(57) ABSTRACT

A LCD lighting control system comprises a lamp, a self-oscillation inverter, a sampling-frequency generating circuit, a detecting-feedback circuit, a modulator and a buck circuit. The LCD lighting control system samples at the preset sampling location in the self-oscillation inverter or the preset sampling location between the self-oscillation inverter and the buck circuit to synchronize the control signal from the modulator and the self-oscillation frequency, to suppress high-voltage ripple effect, and to enhance stability of the system.

### CROSS REFERENCE TO RELATED APPLICATIONS

This application claims the priority benefit of Taiwan application serial no. 93112469, filed May 4, 2004.

### BACKGROUND OF INVENTION

1. Field of the Invention

The present invention relates to a LCD lighting control system, more particularly to a LCD lighting control system adapted to synchronize a self-oscillation inverter and a buck circuit.

2. Description of Related Art

Liquid Crystal Display (LCD) has been widely used in various fields and are replacing traditional CRT Display. Because of the small size, low power consumption and low radiation, LCD has been applied to display system at public place and home. A Royer type inverter, which was invented by Dr. Royer, is applied in LCD. The Royer type transformer comprises a DC/DC buck converter and a DC/AC self-oscillation apparatus. The front-end DC/DC buck converter serves voltage conversion. By controlling a switch in the buck converter, the input direct current is converted to square signals with adjustable pulse width. This method is Pulse Width Modulation (PWM). By storing and releasing energy of an inductor within the circuit, the square signals with adjustable pulse width are converted to signals with lower voltage than the input voltage. The signals are then inputted into the back-end DC/AC self-oscillation inverter.

FIG. 5 is circuit block diagram showing a two-end voltage inverter according to prior art. The two-end voltage converter 500 comprises a DC/AC inverter 502, a fluorescent lamp 504, a lamp current detecting circuit 514, a feedback compensation control circuit 516, a pulse width modulator 518, a frequency generating circuit 508 and a buck circuit 512. The DC/AC inverter 502 is coupled to the buck circuit 512, power source and the fluorescent lamp 504. The lamp current detecting circuit 514 is coupled to the fluorescent lamp 504 and the feedback compensation control circuit 516. The pulse width modulator 518 is coupled to the frequency generating circuit 508 and the buck circuit 512.

Following is the operation of the two-end voltage inverter 500. A step-up transformer in the DC/AC inverter 502 is connected to the primary-side oscillation capacitor of the voltage converter in parallel and to the secondary-side high-voltage blocking capacitor of the voltage converter and two push-pull switches in series. An auxiliary winding of the two-end voltage inverter is adapted for triggering these two push-pull switches for self-oscillation. The lamp 504 also operates with the self-oscillation frequency. The lamp current detecting circuit 514 is adapted for detecting current flowing through the fluorescent lamp 504 and outputting a detecting signal. The feedback compensation control circuit 516 outputs a feedback signal to the pulse width modulator 518 according to the detecting signal. The frequency-generating circuit 508 is adapted for outputting a fixed frequency to the pulse width modulator 518.

In the prior art technology, the pulse width modulator 518 outputs a control signal to the buck circuit 512 according to the fixed frequency and the feedback signal. The buck circuit 512 operates with the frequency of the control signal.

Due to the front-end and back-end operations, the buck circuit 512 and the DC/AC inverter 502 have different operational frequencies. The former operates with the frequency of the control signal; the latter operates with the self-oscillation frequency.

FIG. 6 is a schematic figuration showing the ripple effect on the fluorescent lamp of the prior art two-end voltage inverter. Because the buck circuit 512 and the DC/AC inverter 502 are not synchronized, the asynchronous results in difference frequency and ripple effect on the fluorescent lamp 504.

Therefore, the asynchronous operation of the DC/AC inverter 502 and the buck circuit 512 causes ripple effect. The high-voltage ripple may cause scintillation effect on the fluorescent lamp 504 and make the feedback control of the lamp current unstable. These issues result in instability of the system.

### SUMMARY OF INVENTION

Accordingly, the present invention is directed to a LCD lighting control system. The apparatus samples at the preset sampling locations of the collectors of the first and the second transistor in order to synchronize the frequencies of the buck circuit and the self-oscillation inverter.

The present invention is also directed to a LCD lighting control system. The apparatus samples at the preset sampling location between the self-oscillation inverter and the buck circuit in order to synchronize the frequencies of the buck circuit and the self-oscillation inverter.

The present invention discloses a LCD lighting control system, comprising: a lamp, a self-oscillation inverter, a sampling-frequency generating circuit, a detecting-feedback circuit- and a modulator. The self-oscillation inverter is coupled to a power source and the lamp and is adapted for converting electrical energy from the power source to the lamp. The self-oscillation inverter operates with a self-oscillation frequency. The sampling-frequency generating circuit is coupled to the self-oscillation inverter that samples and measures the self-oscillation frequency for outputting a synchronization frequency. The detecting-feedback circuit is coupled to the lamp and adapted to detect a current flowing through the lamp and perform feedback operation for outputting a feedback signal. The modulator is coupled to the detecting-feedback circuit, the sampling-frequency generating circuit and the self-oscillation circuit to receive and measure the feedback signal and the synchronization frequency for outputting a controlling synchronized with the self-oscillation frequency.

According to an embodiment of the present invention, the sampling-frequency generating circuit samples at a preset sampling location in the self-oscillation inverter. The preset sampling location is at the collector of the first or the second transistor of the self-oscillation inverter.

According to an embodiment of the present invention, the synchronization frequency is single, double, triple, or multiple of the self-oscillation frequency.

The present invention also discloses a LCD lighting control system comprising a lamp, a self-oscillation inverter, a sampling-frequency generating circuit, a detecting-feedback circuit, a modulator, and a buck circuit. The self-oscillation inverter is coupled to a power source and the lamp and is adapted for converting electrical energy from the power source to the lamp. The self-oscillation inverter operates with a self-oscillation frequency. The sampling-frequency generating circuit is coupled to the self-oscillation inverter that samples and measures the self-oscillation frequency for outputting a synchronization frequency. The detecting-feedback circuit is coupled to the lamp and is adapted for detecting a current flowing through the lamp and perform feedback operation for outputting a feedback signal. The modulator is coupled to the detecting-feedback circuit, the sampling-frequency generating circuit and the self-oscillation circuit to receive and measure the feedback signal and the synchronization frequency for outputting a controlling synchronized with the self-oscillation frequency. The buck circuit is coupled to the modulator, the self-oscillation inverter and the power source.

According to an embodiment of the present invention, the synchronization frequency is single, double, triple or multiple of the self-oscillation frequency.

The present invention adopts the method of sampling the direct current pulse of the primary side of the self-oscillation circuit. By sampling, the lamp and the buck circuit are synchronized. Therefore, the present invention reduces the high-voltage ripple effect at the output terminal of the prior art voltage converter, enhances the stability of the system and simplifies the circuit.

In order to make the aforementioned and other objects, features and advantages of the present invention understandable, a preferred embodiment accompanied with figures is described in detail below.

### BRIEF DESCRIPTION OF DRAWINGS

FIG. 1 shows a block-circuit diagram of LCD lighting control system according to an embodiment of the present invention.

FIG. 2 is a time chart of the self-oscillation frequency and the synchronization frequency of a LCD lighting control system according to an embodiment of the present invention.

FIG. 3 is a circuit representing a LCD lighting control system of a single lamp according to an embodiment of the present invention.

FIG. 4A is a circuit showing another LCD lighting control system of another single lamp according to an embodiment of the present invention.

FIG. 4B is a circuit showing a LCD lighting control system of a double lamp according to an embodiment of the present invention.

FIG. 5 is circuit block diagram showing a voltage converter according to prior art.

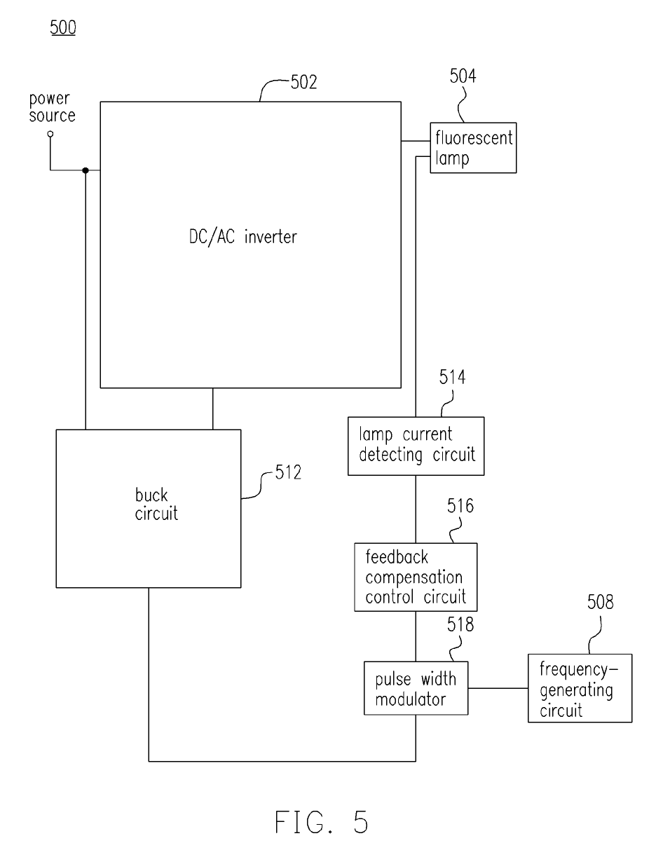

FIG. 6 is a schematic figuration showing the ripple effect on the fluorescent lamp of the prior art voltage converter.

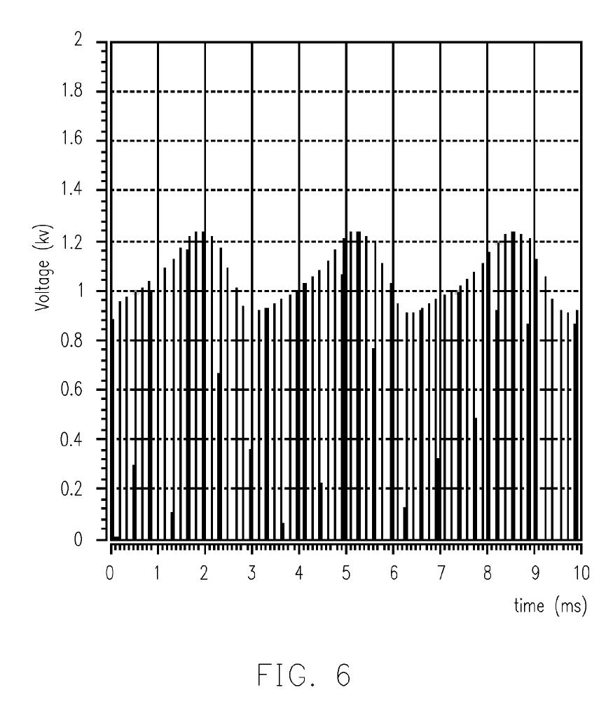

### DETAILED DESCRIPTION

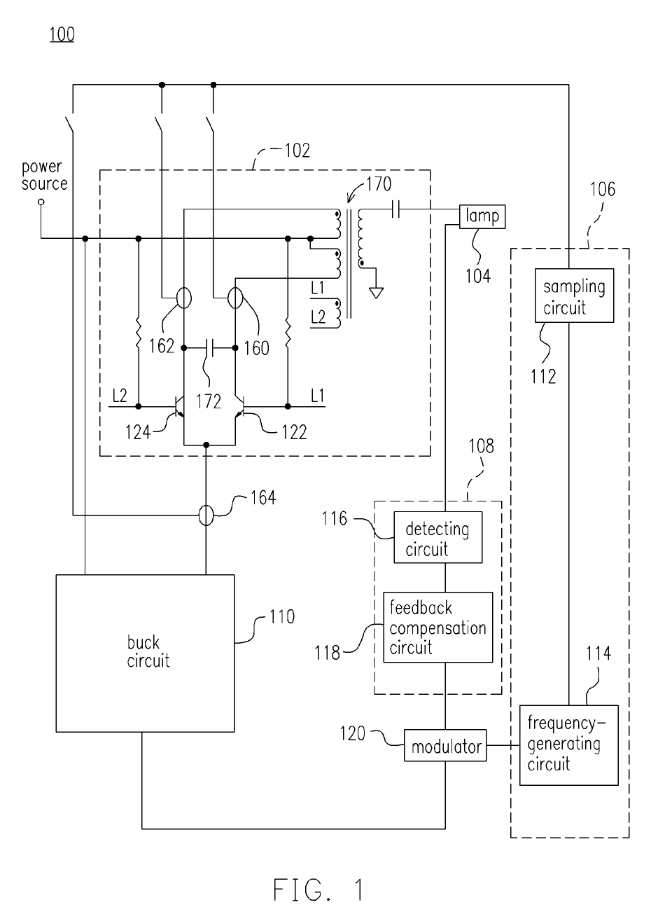

FIG. 1 shows a block-circuit diagram of LCD lighting control system according to an embodiment of the present invention. The LCD lighting control system 100 comprises a lamp 104, a self-oscillation inverter 102, a sampling-frequency generating circuit 106, a detecting-feedback circuit 108, a modulator 120, and a buck circuit 110. One of ordinary skill in the art understands that the self-oscillation inverter 102 can be, for example, a DC/AC inverter to provide alternating current to the lamp 104. The lamp 104 can be, for example, a fluorescent lamp (FL) of a liquid crystal display (LCD), but is not limited thereto.

According to the embodiment, the self-oscillation inverter 102 is coupled to the lamp 104 and operates with a self-oscillation frequency. It should be noted that the self-oscillation frequency can be generated, for example, from the tank circuit composed of the voltage converter 170 and the oscillation circuit 172, but not limited thereto.

The sampling-frequency generating circuit 106 is coupled to the self-oscillation inverter 102. The sampling-frequency generating circuit 106 comprises the sampling circuit 112 to sample the self-oscillation frequency and a frequency-generating circuit 114 coupled to the sampling circuit 112 and the modulator 120 for outputting the synchronization frequency after measuring the self-oscillation frequency.

The detecting-feedback circuit 108 comprises a detecting circuit 116 and a feedback compensation circuit 118. The detecting circuit 116 is coupled to the lamp 104 for detecting the current flowing through the lamp 104 and outputting a detecting signal. The feedback compensation circuit 118 is coupled to the detecting circuit 116 and the modulator 120 to measure the detecting signal for outputting the feedback signal. The detecting circuit 116 can be, for example, a lamp current detecting circuit 116, but is not limited thereto.

The modulator 120 is coupled to the feedback compensation circuit 118, the frequency-generating circuit 114 and the buck circuit 110, for receiving and measuring the feedback signal and the synchronization frequency and outputting a control signal synchronized with the self-oscillation frequency to the buck circuit 110. It should be noted that the modulator 120 can be, for example, a pulse width modulator (PWM), but is not limited thereto.

In the embodiment of the present invention, the buck circuit 110 can be, for example, a DC/DC buck converter, but is not limited thereto.

The sampling circuit 112 samples at preset sampling locations 160 and 162 of the self-oscillation circuit 102 in this embodiment. The preset sampling location 160 can be, for example, a collector of the first transistor 122 or the second transistor 124, but is not limited thereto.

Referring to FIG. 1, the preset sampling location 164 can be located, for example, between the buck circuit 120 and the self-oscillation circuit 102. Different from sampling at the preset sampling locations 160 and 162, the sampling circuit 106 is coupled to the preset sampling location 164 when sampling on the preset sampling location 164 between the buck circuit 120 and the self-oscillation circuit 102.

The present invention samples the pulse direct current of the primary side of the self-oscillation inverter 102.

Referring to FIG. 1, the self-oscillation inverter 102 receives the direct current from the power source and converts it into an alternating current to the lamp 104. The tank circuit composed of the voltage converter 170 and the oscillation capacitor 172 generates a self-oscillation frequency. The self-oscillation inverter 102 and the lamp 104 operate with the self-oscillation frequency.

The sampling circuit 106 then samples the self-oscillation frequency on one of the preset sampling locations 160, 162 and 164, and outputs it to the frequency-generating circuit 114. The frequency-generating circuit 114 measures the self-oscillation frequency and outputs a synchronization frequency to the modulator 120.

The detecting circuit 116 detects the current flowing through the lamp 104 and outputs a detecting signal to the feedback compensation circuit 118. According to the detecting signal, the feedback compensation circuit 118 outputs a feedback signal to the modulator 120.

The modulator 120 receives the feedback signal and the synchronization signal, and measures the signals in this embodiment. The modulator 120 then outputs a control signal synchronized with the self-oscillation frequency to the buck circuit 110.

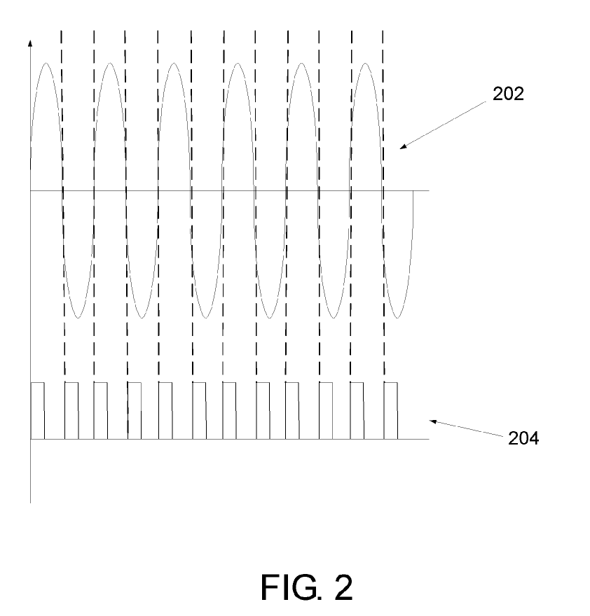

FIG. 2 is a time chart of the self-oscillation frequency and the synchronization frequency of a LCD lighting control system according to an embodiment of the present invention. Referring to FIG. 2, the waveform 202 is the self-oscillation frequency outputted to the lamp 104. The waveform 204 is the control signal outputted from the modulator 120. The waveform 202 of the self-oscillation signal is the operation signal of the lamp 104. According to the waveforms 202 and 204, the control signal outputted from the modulator 120 is synchronized with the self-oscillation frequency of the self-oscillation inverter 102. As a result, the synchronization operation can be a multiple operation.

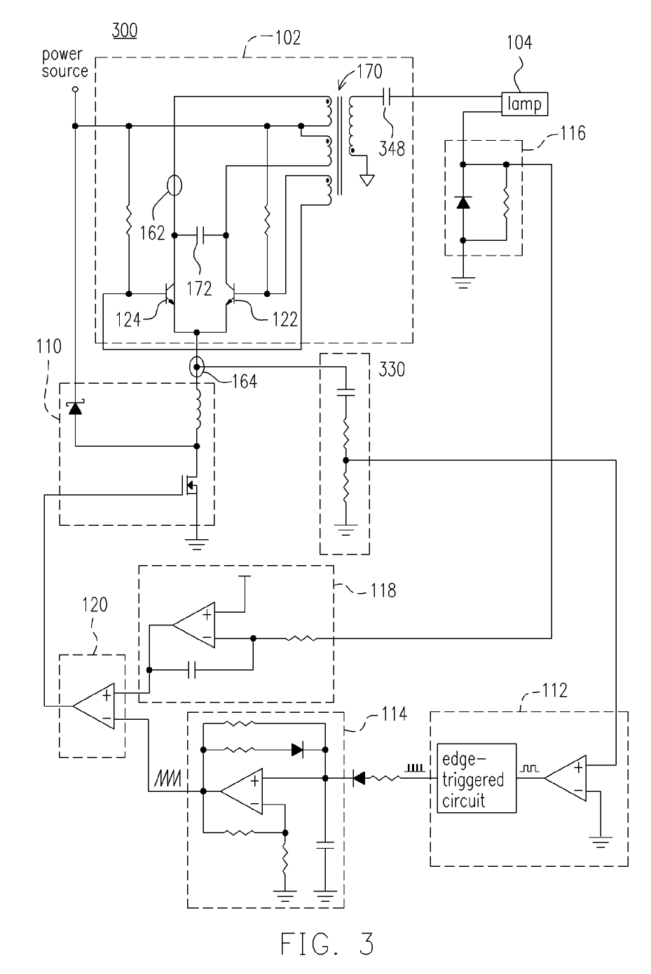

FIG. 3 is a circuit diagram of a LCD lighting control system of a single lamp according to an embodiment of the present invention. The circuit in FIG. 3 represents a detail drawing of the LCD lighting control system in FIG. 1. The circuit, however, is not limited thereto. Referring to FIG. 3, the self-oscillation inverter 102 further comprises a blocking capacitor, which is coupled to a secondary-side high voltage terminal of the voltage converter 170. The secondary side means that both sides of the voltage converter 170 for low voltage/high voltage conversion. The first transistor 122 and the second transistor 124 are two push-pull switches.

In the present embodiment, the preset sampling location 164 is between the self-oscillation inverter 102 and the buck circuit 110. The LCD lighting control system 300 of FIG. 3 further comprises a sampling location circuit 330. According to the circuit of FIG. 3, the sampling circuit 112 can be, for example, an edge-triggered circuit, but is not limited thereto.

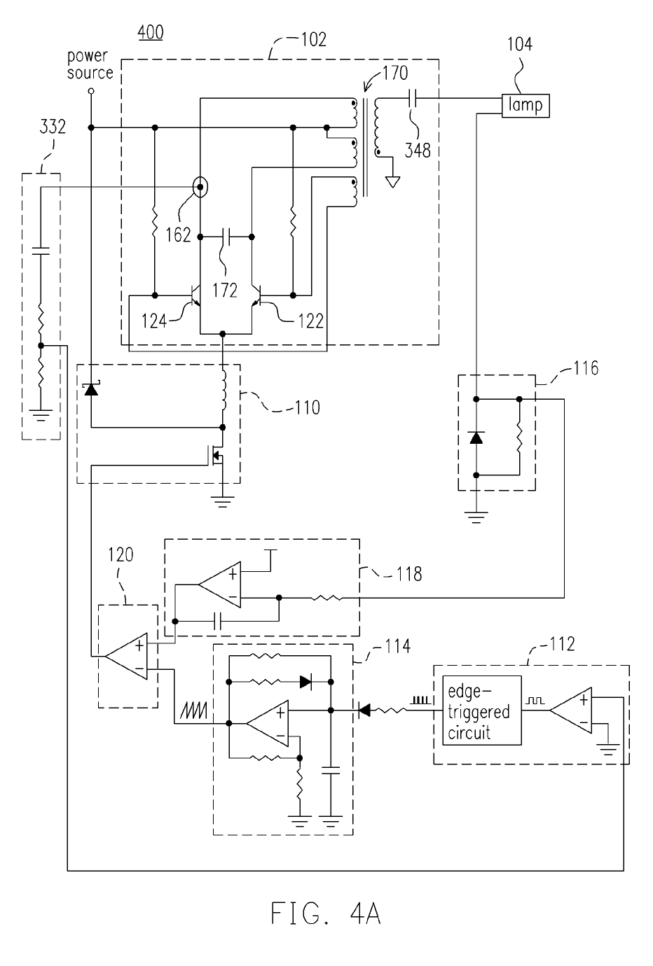

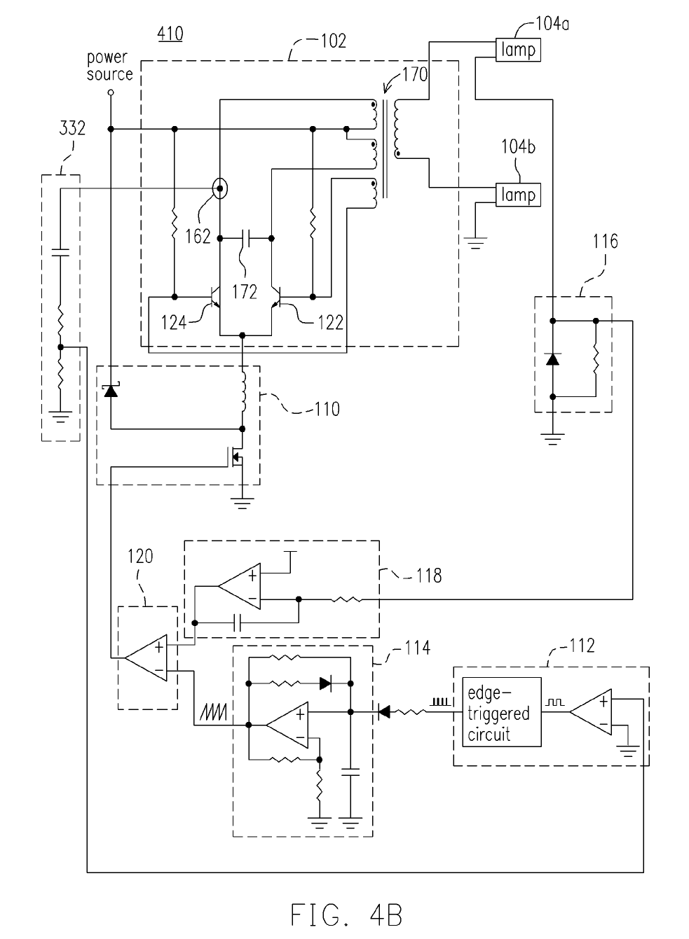

FIG. 4A is a circuit showing a LCD lighting control system of a single lamp according to another embodiment of the present invention. Different from FIG. 3, the preset sampling location 162 is in the self-oscillation circuit 102 in FIG. 4A. In addition, the sampling circuit 112 in FIG. 4A is an edge-triggered multiple circuit. The reason of adopting a multiple circuit being that the frequency sampled at the preset sampling location 160 or 162 is a half of the frequency sampled by the sampling circuit 112. As a result, the sampling circuit 112 uses the edge-triggered multiple circuit to synchronize the self-oscillation frequency and the control signal outputted from the modulator 120.

FIG. 4B is a circuit showing a LCD lighting control system of a double lamp according to an embodiment of the present invention. Compared with FIG. 4A, the LCD lighting control system of FIG. 4B comprises lamps 104a and 104b. The method of obtaining the signal of the LCD lighting control system in FIG. 4B is as same as in FIG. 4A. But the connection method of the secondary side of the voltage converter 170 in FIG. 4B is different from that in FIG. 4A. Each of two output terminals of the voltage converter 170 is coupled to the lamp 104a or 104b for connecting the lamps 104a and 104b in series. One of ordinary skill in the art will understand that the LCD lighting control system of the present invention can be applied to a multiple-lamp liquid crystal display. The present invention is not limited thereto.

In the embodiments of the present invention described above, the frequency of the buck circuit 110 is single, double, triple, or multiple of the alternating current signal of the self-oscillation inverter 102.

In the embodiments of the present invention described above, the buck circuit 110, the self-oscillation inverter 102, the lamp 104, the detecting circuit 116, the feedback compensation circuit 118 and the modulator 120 constitute the closed circuit of lamp-current control system.

According to the above embodiments of the present invention, the synchronization frequency outputted from the frequency-generating circuit 114 varies with the self-oscillation frequency.

Accordingly, the LCD lighting control system of the present invention has following advantages:

(1) When the buck circuit and the self-oscillation inverter of the synchronization operation system of the present invention are synchronized, a frequency point that causes interference can be eliminated.

(2) By synchronizing the buck circuit and the self-oscillation inverter, the LCD lighting control system of the present invention reduces the high-voltage ripple effect and enhances the stability of the system.

(3) The tank circuit composed of the voltage converter and the oscillation capacitor determines the synchronization signal of the LCD lighting control system of the present invention.

(4) The LCD lighting control system merely modifies the traditional fluorescent lamp and is not very complicated.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A LCD lighting control system, comprising:
a lamp;
a self-oscillation inverter, coupled to a power source and the lamp, for converting electrical energy from the power source to the lamp, the self-oscillation inverter operating with a self-oscillation frequency;
a sampling-frequency generating circuit, coupled to the self-oscillation inverter, for sampling and measuring the self-oscillation frequency for outputting a synchronization frequency;
a detecting-feedback circuit, coupled to the lamp, for detecting a current flowing through the lamp and perform feedback operation and outputting a feedback signal; and
a modulator, coupled to the detecting-feedback circuit, the sampling-frequency generating circuit and the self-oscillation circuit, for receiving and measuring the feedback signal and the synchronization frequency for outputting a controlling synchronized with the self-oscillation frequency.

2. The LCD lighting control system of claim 1, wherein the sampling-frequency generating circuit samples at a preset sampling location in the self-oscillation circuit.

3. The LCD lighting control system of claim 2, wherein the self-oscillation inverter comprises a first transistor and a second transistor.

4. The LCD lighting control system of claim 3, wherein the preset sampling location is a collector of the first transistor.

5. The LCD lighting control system of claim 3, wherein the preset sampling location is a collector of the second transistor.

6. The LCD lighting control system of claim 1, wherein the sampling-frequency generating circuit comprises:
a sampling circuit, coupled to the self-oscillation circuit, for sampling the self-oscillation frequency; and
a frequency-generating circuit, coupled to the sampling circuit and the modulator, outputting the synchronization frequency after measuring the self-oscillation frequency.

7. The LCD lighting control system of claim 1, wherein the detecting-feedback circuit comprises:
a detecting circuit, coupled to the lamp, for detecting the current flowing through the lamp and outputting a detecting signal; and
a feedback compensation circuit, coupled to the detecting circuit and the modulator, for measuring the detecting signal for outputting the feedback signal.

8. The LCD lighting control system of claim 1, further comprising a buck circuit coupled to the modulator, the self-oscillation inverter and the power source.

9. The LCD lighting control system of claim 8, wherein the buck circuit is a DC/DC buck circuit.

10. The LCD lighting control system of claim 1, wherein the self-oscillation inverter is a DC/AC inverter.

11. The LCD lighting control system of claim 1, wherein the synchronization frequency is single, double, triple, or multiple of the self-oscillation frequency.

12. A LCD lighting control system, comprising:
a lamp;
a self-oscillation inverter, coupled to a power source and the lamp, for converting electrical energy from the power source to the lamp, the self-oscillation inverter operating with a self-oscillation frequency;
a sampling-frequency generating circuit, coupled to the self-oscillation inverter, for sampling and measuring the self-oscillation frequency and outputting a synchronization frequency;
a detecting-feedback circuit, coupled to the lamp, for detecting a current flowing through the lamp and perform feedback operation and outputting a feedback signal;
a modulator, coupled to the detecting-feedback circuit, the sampling-frequency generating circuit and the self-oscillation circuit, for receiving and measuring the feedback signal and the synchronization frequency and outputting a controlling synchronized with the self-oscillation frequency; and
a buck circuit, coupled to the modulator, the self-oscillation inverter and the power source.

13. The LCD lighting control system of claim 12, wherein the sampling-frequency generating circuit comprises:
a sampling circuit, coupled to the self-oscillation circuit, for sampling the self-oscillation frequency; and
a frequency-generating circuit, coupled to the sampling circuit and the modulator, for outputting the synchronization frequency after measuring the self-oscillation frequency.

14. The LCD lighting control system of claim 12, wherein the detecting-feedback circuit comprises:
a detecting circuit, coupled to the lamp, for detecting the current flowing through the lamp for outputting a detecting signal; and
a feedback compensation circuit, coupled to the detecting circuit and the modulator, for measuring the detecting signal for outputting the feedback signal.

15. The LCD lighting control system of claim 12, wherein the buck circuit is a DC/DC buck circuit.

16. The LCD lighting control system of claim 12, wherein the self-oscillation inverter is a DC/AC inverter.

17. The LCD lighting control system of claim 12, wherein the synchronization frequency is single, double, triple, or multiple of the self-oscillation frequency.
